(19) United States
(12) Patent Application Publication
(10) Pub. No.: US 2014/0292538 A1
(43) Pub. Date: Oct. 2, 2014

(54) INTELLIGENT COUPLER DEVICE FOR UTILITY METER AND METHOD FOR OPERATING THEREOF

(71) Applicants: Viraj Kumar Pathi, Secunderabad (IN); Vamsi Krishna Sadhu, Secunderabad (IN); Vamsi V Prasad, Secunderabad (IN); Satish Maddela Babu, Secunderabad (IN); Anil Kumar Vangala, Secunderabad (IN); Ramakoteshwarudu Vangala, Secunderabad (IN)

(72) Inventors: Viraj Kumar Pathi, Secunderabad (IN); Vamsi Krishna Sadhu, Secunderabad (IN); Vamsi V Prasad, Secunderabad (IN); Satish Maddela Babu, Secunderabad (IN); Anil Kumar Vangala, Secunderabad (IN); Ramakoteshwarudu Vangala, Secunderabad (IN)

(73) Assignee: Viraj Kumar Pathi, Secunderabad (IN)

(21) Appl. No.: 14/343,482

(22) PCT Filed: Oct. 7, 2011
(86) PCT No.: PCT/IN2011/000697

§ 371 Date: Jun. 3, 2014

(30) Foreign Application Priority Data
Sep. 7, 2011 (IN) 3075/CHE/2011

(51) Int. Cl. G01D 4/00

(52) U.S. Cl. CPC G01D 4/00
USPC 340/870.39

(57) ABSTRACT

An intelligent coupler device for utility meters comprising a communication module to maintain a two-way communication with its network gateway and other neighboring devices through respective communication channels; a control unit configured for processing and flow control of any communication events; an oscillator in connection with the control unit via interface to maintain the instruction clock; a memory unit for storing and processing the incoming and outgoing data; a Real Time Clock (RTC) in connection with control unit to fetch and/or set current date, time and the like; a primary power port configured for supplying power to all components.

### FIELD OF THE INVENTION

The present invention relates to a device and method for remote operations and control, and more specifically, to a communication capable, versatile, intelligent coupler device for utility meters to fetch, process, and push, the entire meter related data through respective available communication channels. The said device and the method is so designed to exploit the full features of available communication module to form an omnipotent communication network for utility meter in any desired topology taking into consideration the associated environmental conditions. In addition the said device has modularity to interchange its constituent components seamlessly at any time with a component of respective standards with minimal effort to keep the engineering costs low.

### BACKGROUND ART

Utility meters can be made communication capable by coupling them with communication devices. This has been the practice in the deployment of AMR/AMI meters. The need arises here to reduce the power usage by these communication devices in the event of increased number of data sample connections from the designated utility meters.

Utilities that distribute commodities, such as gas, water, or electricity over a commodity distribution network face a perpetual challenge with meter reading, disconnection from, and reconnection to the grid. These three processes consume an average work effort of 90% for a utility's field services department, especially when it comes to residential and commercial accounts which contribute to a lower revenue base and higher maintenance cost. In order to efficiently bill and collect, utility meters (e.g., water, electricity, gas) need to be read, disconnected, reconnected, maintained, and repaired in an accurate and expedient manner. However, utilities face perpetual challenges with these processes. First, a utility company may deploy field agents to manually perform these processes where these utility meters are located, consuming a great amount of resources. Second, not only is this highly inefficient, some field agents, without proper supervision, may be prone to corrupt practices (e.g., taking bribes for recording inaccurate readings). Third, because utility meters are located in remote locations, they are highly susceptible to tampering and pilfering. This may lead to inaccurate readings, uncompensated utility services, lack of notice of problems to the utility company, other losses and setbacks. Further, it is often difficult for the service person to access the meter for reading, inspection, and maintenance. Therefore, manual meter reading is a highly labor intensive, inefficient, and expensive endeavor.

The present disclosure provides a device that may be retrofit into existing meter systems (e.g., grid) or installed in new meter units that enables cost effective is measurement of commodity usage by a consumer. Also described are methods and meters capable of providing remote networked meter reading and control.

The current meter reading methodologies are labor intensive, expensive, error prone, inefficient and often provide data and information too late to be a decision making tool. In addition there is a need today because of the constant customer mobility in which they change residences many times over a few years creating the need for the utility to connect and disconnect its meters on a continuous basis. A better means for providing these two functions is needed by the utility company today. Better data makes for better decision-making and lower operating costs to benefit the utility owners and their customers.

In the prior art the use of the Automatic Meter Reading (AMR) technologies was a major endeavor by utility companies around the world to read their commodity meters. This effort was driven by the increased costs of operations of utility enterprises and the need for competitiveness in the market place. The technology to read the meter usage was not very sophisticated, it was easily done and generally reliable, the critical need is to get this usage data back to the utility so that its staff can utilize the data to make operational decisions and to timely and effectively bill the customers for usage. The AMR effort can be considered to occur across three different spaces; the customer space, the Internet space and the utility space. Affordable and reliable connections between these spaces are what are required to make a system function efficiently and to provide the seamless integration necessary for a competitive utility.

Some of the drawbacks in current networks include: Installation of fixed networks, Maintenance requirements of these networks, Inability to easily optimize these networks, Difficulty in updating of the networks, Lack of redundancy and Total cost and installation of operation

Based on the shortcoming in the existing methodologies, there is a need for a device that leverages all the available technologies to simplify installation, operations, monitoring, maintenance, affordable, efficient and reliable, versatile and to lower costs while still providing a level of service needed to allow the utility company to meet its service requirements to its customers economically. The subject invention addresses these problems and shortcomings specifically by integrating a set of utility customers as customer supported access points, which support a major part of the backhaul network by using their existing Internet connections to connect the mesh network nodes to the global communication network.

An U.S. Pat. No. 7,312,721 describes a data collector device, comprising: an electronic utility meter that collects and stores billing data related to a commodity consumption; and a network communication device for communicating with downstream utility meters and to a remote location that processes said billing data, wherein the data collector communicates wirelessly with downstream utility meters to read and store billing data contained in the downstream utility meters. The data collector communicates the billing data to a remote location for processing.

Another U.S. Pat. No. 7,304,587 illustrates a meter reading network system comprising: a plurality of utility meters, a plurality of sensors, a plurality of utility meters, and a plurality of meter data collectors in communication with at least one of the plurality of sensors including a radio frequency telemetry module to transmit the utility usage data and also positioned in radio frequency communication with at least one other of the plurality of meter data collectors.

A further U.S. Pat. No. 7,058,524 describes a wireless electrical power metering system, which contains a processor with multi-channel capabilities, a wireless transceiver, and a power meter attached to measure the power consumption at a location. This power metering system and method also discusses routing the power meter data to a second residence using an external power line network as the carrier. This method however lacks the mesh hopping capability inherent in the wireless embodiment provided herein in the current application

Several other Patents/applications which include as prior art are, U.S. Pat. Nos. 7,020,566, 7,304,587, 7,312,721, 6,396,839, 6,333,975, 6,088,659, 2009267792 and 2011193719.

In the present scenario, the types of devices, which are being coupled to the utility meters, are coming as custom models for a specific kind of meter and/or communication option. However, the increase in the R & D happening in the field area and the available options for communications are making the said types of devices obsolete within shorter life periods. This brings the need to design a multi-purpose coupler-device for utility meters, which gives the end-users to choose the features suitable features on the said device while being cost effective. The said device shall give the end-users choice to choose from the features such as including but not limited to communication module and respective channel; memory capacities on board; utility meter integration modes; and modes of power supplies.

### SUMMARY OF INVENTION

Therefore in order to eliminate the disadvantages as discussed in the prior art, herein disclosed an intelligent coupler device for the metering units that handles data transactions with existing utility meter, over dedicated standard communication channel available at the utility meter. The said device seats with the utility meters for acquiring the respective utility meter's data through dedicated standardized data ports available at the utility meter; make the meter into a communication capable ‘Smart Meter’; while being economical with provision for option to choose the best available ‘communication equipment’ (wired or wireless) to form a robust communication network for utility meters to make them available for remote operations.

Such as herein described, there is provided an intelligent coupler device for the utility meters comprising of: a communication module to maintain a two way communication with its network gateway and other neighboring devices through respective communication channels; a control unit configured for processing and flow control of any communication events; an oscillator in connection with the control unit via interface to maintain the instruction clock; a memory unit for storing and processing the incoming and outgoing data; a Real Time Clock (RTC) in connection with control unit to fetch and/or set current date, time and the like; a primary power port configured for supplying power to all components.

As per an object of the present invention the device is configured to handle data transactions with the utility meters in data formats as per open standards including but not limited to ANSI, IEEE 62056-53, IEEE 62056-61, INDIAN COSEM or a custom protocol as there.

As per yet another object of the present invention the device is further configured to interact to external world over available communication channel with the said device in pre-defined data formats of choice either as per open standards including but not limited to ANSI, DLMS or custom protocol as there.

As per an embodiment of the present invention, the device provides a choice to interchange the existing communication module on the said device with other communication module on choice, preventing the device from becoming obsolete if a change of communication option is needed.

As per another object of the present invention, the devices forms a secure network of utility meters to maintain a 2-way communication over authenticated and encrypted communication channels which can wired or wireless.

A further object of the present invention is to provide devices which are capable to form Omni-potent communication network of utility meters with suitable topology including but not limited to star, mesh and tree network topologies.

As per an exemplary embodiment of the present invention, there is provided options to limit or enhance the functional capabilities of the said device by providing options for choosing whether:
i. To Have communication channels on device
ii. To Have storage on-board for the device
iii. To have either of the features i. or ii. Or both the features as in i. and ii. Based on the need.

Further embodiment of the present invention is to provide options for scheduling data transmission events from the said device so that the power consumed in receiving can be reduced. Also the devices are provided with auxiliary (secondary) power supplies to increase the availability of the device even in the event of power failure at the mains (primary) power supply.

In accordance with one aspect of the invention, there is provided a device configurable as the gateway for the plurality of utility meters coupled to the said devices.

In accordance with another aspect of the invention, there is provided devices capable for responding to their respective network gateway, which can receive/or, transmit data-embedded communication signals over secure communication channels in which the said devices are operating.

Furthermore, the invention takes care of any such events by passing the information of the new network gateway, which will be replacing the existing network gateway. This information is shared through the network gateway to plurality of said devices over common secure communication channels.

### BRIEF DESCRIPTION OF THE ACCOMPANYING DRAWINGS

FIG. 1 illustrates a general block diagram of the device representing its constituents in accordance with the present invention;

FIG. 2 illustrates a pictorial depiction of possible mesh network, which is formed when a plurality of devices is energized and a gateway is made available for these devices to respond in accordance with the present invention;

FIG. 3 illustrates the control flow in the device while the device is energized and is in operation in accordance with the present invention.

FIG. 4 illustrates the detailed control flow vide different sub routines in the device while the device is energized and is in operation in accordance with the present invention.

### DETAILED DESCRIPTION

Various exemplary embodiments of the present disclosure may be directed to a coupler device and method for providing monitoring and control. It should also be appreciated that while the device have been developed for utility services such as electricity, water, and gas, other various applications may also be provided. In one embodiment, the systems described herein may be used to monitor and remote control multiple utility grids and commodity distribution systems such as electricity, water, or gas grids and distribution systems; industrial application and infrastructure including but not limited to manufacturing and pharmaceutical plants using a synchronized wired and wireless networks. In an alternate embodiment, the systems and methods described herein may be applied to television, cable service, Internet service, pollution monitoring, emissions monitoring, industrial infrastructure, and commodity supply networks.

For meeting such objectives herein disclosed a coupling device which seats with the utility meters for acquiring the respective utility meter's data through dedicated standardized data ports available at the utility meter. The disclosed device can couple with a wide range of utility meters. The device also adhere to internationally approved standards related to ‘data handling’ in the case utility meters including but not limited to DLMS, MODBUS.

The said device is a communication capable device to fetch, process, and push meter related data through respective communication channels available. The said device is so designed to exploit the full features of available communication module to form an omnipotent communication network for utility meter in any desired topology taking into consideration the associated environmental conditions. The said device has modularity to interchange its constituent components seamlessly at any time with a component of respective standards with minimal effort to keep the engineering costs low.

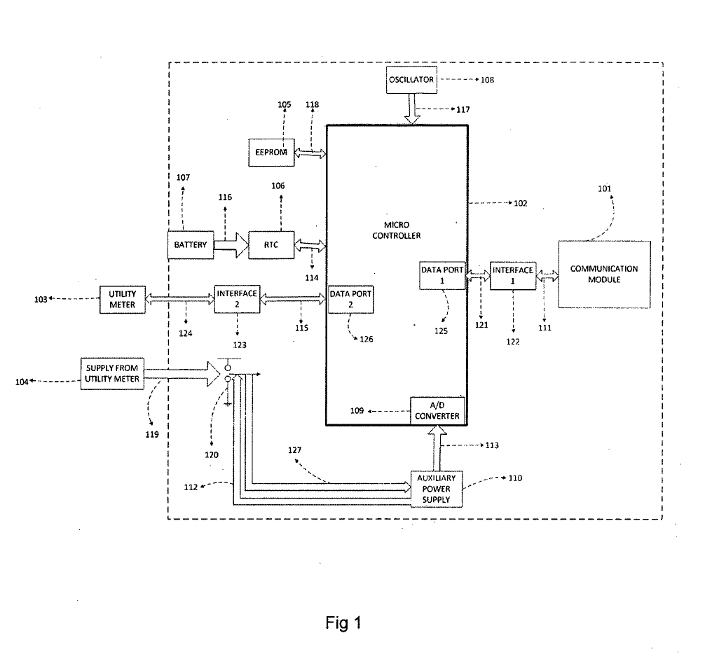

As illustrated in FIG. 1, which depicts the General Block Diagram of the said device representing its constituents. The perimeter of the said device depicted in FIG. 1 is represented with a perforated line. All the components within this perimeter are constituents of the said device. The components represented which are outside the perforated in FIG. 1 represent external device with which said device is coupled.

The said device constitutes of a COMMUNICATION_MODULE represented in FIG. 1 as 101. The COMMUNICATION_MODULE 101 will allow the said device to maintain a two-way communication with its NETWORK_GATEWAY and/or other neighboring devices through respective communication channel. This COMMUNICATION_MODULE 101 is interfaced to the MICRO-CONTROLLER, 102 of FIG. 1 through interface INTERFACE-1 represented as 122. The COMMUNICATION_MODULE 101 will interact with the MICRO-CONTROLLER 102 via INTERFACE-1 122, to intimate MICRO-CONTROLLER 102 of any communication events or to transfer the received data from the communication channel to the MICRO-CONTROLLER.

The dark thick lined longitudinal block inside represented in the FIG. 1 with 102 is the MICRO-CONTROLLER of the said device. It is the control unit of the device where the process and flow control of the device resides. The MICRO-CONTROLLER 102 of FIG. 1 is constitutes of components including but not limited to Analog-to-Digital Converter, A/D CONVERTER represented as 109, DATA PORT1 represented as 125, DATA PORT2 represent as 126. The MICRO-CONTROLLER 102 also has interfaces with OSCILLATOR 108 via Path 117 to maintain its instruction clock. Path 117 here represented direction of signal from OSCILLATOR 108 to MICRO-CONTROLLER 102. The MICRO-CONTROLLER 102 is interfaced to an EEPROM represented in FIG. 1 as 105, which acts as ON_BOARD_MEMORY for the said device. The bi-directional arrow 118 here represents the two-way data-transactions that exist between MICRO-CONTROLLER 102 and the EEPROM 105. The MICRO-CONTROLLER 102 is interfaced to a Real Time Clock (RTC) represented in FIG. 1 as 106 via path 114 to fetch and/or set current date, time and weekday. The bi-directional arrow 118 here represents the two-way data-transactions that exist between MICRO-CONTROLLER 102 and the RTC 106. The MICRO-CONTROLLER 102 will maintain two-way data transactions with utility meter at 103 through DATA PORT2 124 and the INTERFACE-2 123 via path 115 and path 124 respectively as shown in the block diagram in FIG. 1. The MICRO-CONTROLLER 102 has a primary power port represented as 120 in FIG. 1.

The said device has a PRIMARY_POWER_PORT, represented as 120 in FIG. 1, energizes all the components on the said device. This PRIMARY_POWER_PORT 120 will draw its power from the respective utility meter, represent in FIG. 1 as SUPPLY_FROM_UTILITY_METER 104, if the respective utility meter can provide for sufficient power. The path from SUPPLY_FROM_UTILITY_METER 104 to the said device is shown as a unidirectional arrow representing flow of power.

As an embodiment to the present invention the said device also has provision for an AUXILIARY_POWER_SUPPLY represented as 110 in FIG. 1. This AUXILIARY_POWER_SUPPLY 110 will take the responsibility of primary power source and supply for the power needs of the said device when the respective utility meter does not have the provision to supply power to the said device. The path 112 in FIG. 1 indicates the power supply direction from the respective AUXILIARY_POWER_SUPPLY 110 to the PRIMARY_POWER_PORT 120 of the said device.

This AUXILIARY_POWER_SUPPLY 110 is interfaced to the A/D CONVERTER 109 of MICRO-CONTROLLER 102 via path 113. The path from AUXILIARY_POWER_SUPPLY 110 to A/D CONVERTER 109 of MICRO-CONTROLLER 102 is shown as a unidirectional arrow representing flow of voltage signal.

The said device also has provision at AUXILIARY_POWER_SUPPLY 110 to incorporate a rechargeable battery. This rechargeable battery will draw its power from the utility meter SUPPLY_FROM_UTILITY_METER 104 via the PRIMARY_POWER_PORT 120 through the path 127.

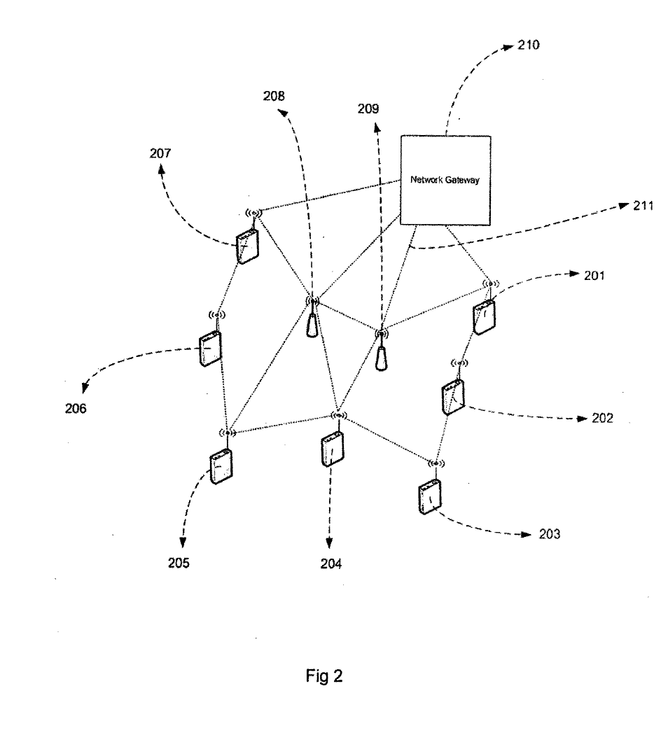

As illustrated in FIG. 2, which is the pictorial depiction of possible mesh network, which will be formed, when a plurality of said devices is energized and a NETWORK_GATEWAY of said type is made available for these devices to respond to.

In the FIG. 2 the nodes at 201, 202, 203, 204, 205, 206, and 207 represent a cluster of said devices respectively. These networks of said devices are interconnected to each other and to their respective NETWORK_GATEWAY through communication links. One such link is represented in the FIG. 2 as 211. A network under certain conditions including but not limited to terrain, topology and environment at the field area might require the presence of ROUTERS represented in the figure at 208 and 209 respectively. Further a communication network of said devices will require the presence of a NETWORK_GATEWAY for the said devices to maintain communications through common communication channel COMM_CHANNEL. The NETWORK_GATEWAY in FIG. 2 is represented at 210.

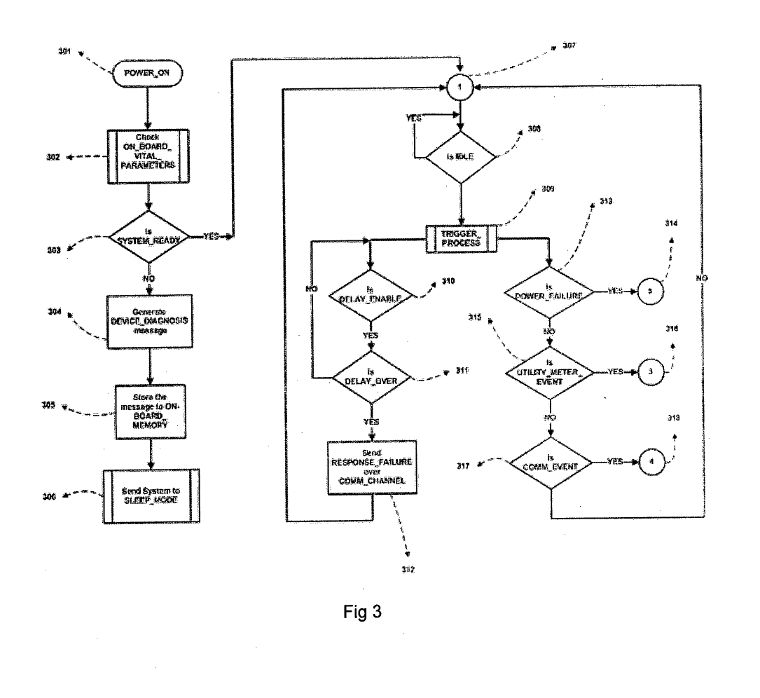

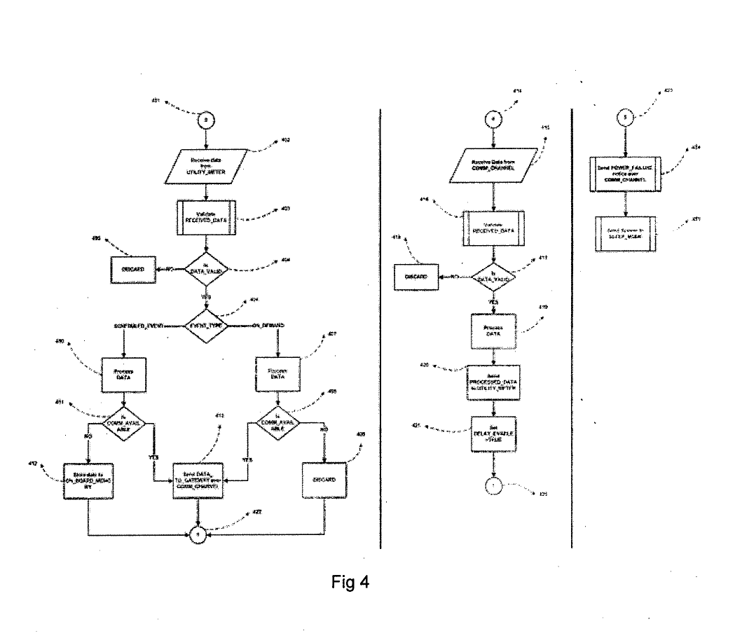

Further, FIG. 3 & FIG. 4 illustrates the control flow in the said device while the said device is energized and is in operation. The flow has been further broken down in to two separate parts namely FIG. 3 & FIG. 4 for convenience of distinguishing between ‘Main Routine’ and ‘Sub-Routines’.

NOTE: The following connectors in of FIG. 3 and FIG. 4 are same and represent the same positions in the control flow of the said device.
Connector 307 of FIG. 3 equals connector 422 of FIG. 4
Connector 314 of FIG. 3 equals connector 423 of FIG. 4
Connector 316 of FIG. 3 equals connector 401 of FIG. 4
Connector 318 of FIG. 3 equals connector 414 of FIG. 4

The flow in FIG. 3 is explained as follows.

The said device gets energized through mains power supply upon availability of power as represented here with 301. The said device will then check for the performance of the itself by reading into the ON_BOARD_VITAL_PARAMETERS represented here as 302. Upon fetching the data related to ON_BOARD_VITAL_PARAMETERS from the step 302, the said device will then validate the received parameters values and raise the flag for SYSTEM_READY. The said device will then make decision at 303 for choosing the process path based on the status of SYSTEM_READY flag.

If the condition is not satisfied at the decision point 303 the control flow will shift to 304 as depicted in the FIG. 3, where the said device will generate DEVICE_DIAGNOSIS message. This message is stored into the ON_BOARD_MEMORY as depicted in 305. The said device will then enter SLEEP_MODE as represented here in 306.

If the condition is satisfied at the decision point 303 the control flow will shift to 307 as depicted in the FIG. 3, where the said device will enter a state of IDLE awaiting event occurrence. The said device will wait for the events to occur as depicted in the FIG. 3 as 308. If any event occurs the control will move on to 309 where a TRIGGER_PROCESS is initiated. From here the device will maintain a dual path for DELAY_PROCESS and other for identifying the type of event that occurred on the said device.

The events occurring are classified based on their priority as POWER_FAILURE, UTILITY_METER_EVENT, and COMM_EVENT respectively. After TRIGGER_PROCESS the control will shift to 313 where the said device will check whether it is a POWER_FAILURE event. If it is POWER_FAILURE event the control will shift to POWER_FAILURE_EVENT_HANDLER here depicted as 314. If it is not POWER_FAILURE event the control will shift to decision point 315 to check whether it is a UTILITY_METER_EVENT. If it is an UTILITY_METER_EVENT the control will then shift to UTILITY_METER_EVENT_HANDLER depicted in the FIG. 3 as 316. If it is not an UTILITY_METER_EVENT the control will then shift to decision point 317 where the said device will decide whether the occurred event is COMM_EVENT. If it is COMM_EVENT the control will then shift to COMM_EVENT_HANDLER depicted as 318.

In the event of a DELAY_PROCESS the control will shift to 310 where the said device will check whether the DELAY_ENABLE flag is still enabled at the decision point 310. If flag is enabled the control will move to the decision point to check whether the required delay has elapsed at the decision point 311. If the delay is elapsed the device will then generate RESPONSE_FAILURE message for the corresponding utility meter and send the message through communication channel represented as COMM_CHANNEL the activity is depicted here with 312.

The flow in FIG. 4 is explained as follows.

FIG. 4 has three sub-sections each beginning at respective start points namely 401, 414 and 423 representing the respective UTILITY_METER_EVENT_HANDLER, COMM_EVENT_HANDLER, and POWER_FAILURE_EVENT_HANDLER.

### Power Event Failure Handler:

POWER_FAILURE_EVENT_HANDLER is a sub-task of the said device, which constitutes the said device's response in the event of POWER_FAILURE failure from the ‘Primary Power Source’. The control will come to POWER_FAILURE_EVENT_HANDLER at 423 in the FIG. 4. Then the control will move to 424, where the said device will send a POWER_FAILURE message through the communication channel available at the said device represented as COMM_CHANNEL. The said device will then enter SLEEP_MODE as depicted at 425.

### Utility Meter Event Handler:

UTILITY_METER_EVENT_HANDLER is a sub-task of the said device, which constitutes the said device's response if UTILITY_METER_EVENT occurs. A UTILITY_METER_EVENT will be a data transaction from the respective utility meter, where the respective utility meter sends a certain amount of data through the dedicated data line running between the said device and the respective utility meter. The said device will receive the data sent by the respective utility meter through the dedicated data line and buffers it as represented in 402. The said device will then validate the data by applying a predefined process on the RECEIVED_DATA as depicted at 403.

If DATA_VALID flag is false, said device would discard the RECEIVED_DATA.

If DATA_VALID flag is true, said device would then move the control to decision point 404 where the said device will evaluate the cause of the UTILITY_METER_EVENT.

The different features of the said devices is discussed below:

### Feature1:

The said device is intended to couple with an existing utility meter which has any of the standard data output ports including but not limited to RS232, RS485, open-collector (pulse) output, Infrared Data Acquisition (IrDA) port. The said device further has a provision for coupling to any of the standardized data outputs including but not limited to RS232, RS485, open-collector (pulse) output and Infrared Data Acquisition (IrDA) port. The said device can then be coupled to one of aforesaid data output ports as available at the utility meter as a dedicated line to maintain data transactions with the respective utility meter.

The provision for various data transaction ports on the device provides the flexibility to use the said device with utility meters of any make seamlessly. By having a generalized provision for various data ports the end-user can interface the device with a utility meter through the data port compatible with the data ports available at the utility meter. This plug & play options for maintaining data ports on the device reduces the cost of the said device as the said device can have only that data port on it, which is compatible with the respective meter. However, if the need be, the said device can be explicitly provided with more than one data ports with minimal effort.

### Feature2:

The said device in the invention is developed in such a fashion to handle the data transactions with the utility meters in any desired format including but not limited to ANSI, IEEE 62056-53, IEEE 62056-61, INDIAN COSEM or a custom protocol as there. Provision shall be there to obtain data from the utility meter and convert the obtained data to a common standard data format including but not limited to ANSI, IEEE 62056-53, IEEE 62056-61, INDIAN COSEM or a custom protocol as there which is desired by the end-user for further processing after retrieval from the said device to an external system over secure communication channels which may be wired or wireless communication channels.

This feature gives the flexibility to choose among the range of available data output ports as in the case of a utility meter with more than one data output port, while not requiring any change at the hardware of the said device.

### Feature3:

The said device interacts with respective NETWORK_GATEWAY and/or its neighbor devices through an available communication channel at the said device. The data placed by the said device on the communication channel will be in a pre-defined format as per open standards including but not limited to ANSI, DLMS or a custom protocol as there.

This feature makes the said device to be able to maintain seamless communication with utility meter with of any internal data format, while acting as and data format modifier when pushing the respective utility meter data to the external world (the gateway in this case) to maintain a common data format as available at the end-user.

### Feature4:

The invention gives the choice to interchange the existing communication module on the said device with other communication module as per the need. The said, device has an interfacing mechanism INTERFACE-1 122 on it to connect to a COMMUNICATION_MODULE 101. Thus the end-user can retain the said device and by only changing the COMMUNICATION_MODULE 101 and respective interface mechanism INTERFACE-1 122. This feature allows the said device to be able to integrate with variety of communication modules of different modes of communication include but not limited to zigbee, 6LoWPAN, and other devices communicating on low power ISM band frequencies.

Such a provision to have communication module of choice on the said device makes it reusable and thus increasing the productive lifetime of the device. This feature prevents the device from becoming obsolete if a change of communication option is needed. Thus it saves the NRE costs that included when a change of design has to be made on the device whenever the communication option is being changed.

### Feature5:

The invention allows the said devices to form a secure communication for network of utility meters. The said devices upon energizing can poll messages by exploiting the full capacity of the respective communication channels available at the said device. This is done by the plurality of such devices in the proposed network. The said devices can identify their neighbors by these messages received over the respective channel.

Through these messages the clusters of said devices are made ready to form a network of utility meters and this cluster will turn into a formal network upon the availability of a network monitoring device or the so called gateway.

### Feature6:

The invention further enhances the feature as discussed in the above Feature5 to improve the quality of network-of-meters thus formed as explained in Feature5. The said devices take the full advantage of the available communication channel to form a suitable communication network for utility meters with suitable network topology including but not limited to star, mesh, or tree. The said devices forms such communication network topologies based on the terrain, environmental conditions and the available communication technology at the said device.

The said device can tend to form a mesh network based on the availability of suitable conditions with respect to factors including but not limited to terrain and environmental conditions. This mesh network will give the strength to form multiple communication paths to avoid any single point of failure. This mechanism is important as it gives robustness to the network in terms of communication availability and network availability.

### Feature7:

The said device is by default a full-function device, which can perform all the intended activities as desired from a robust AMI utility meter coupler device. However, the said device further provides options to limit or enhance the functional capabilities of the said device by providing options for choosing whether;

a. To have only communication channels on device. It may be required in a special case wherein it is enough for the said device to push the Utility Meter's data to the respective gateways via a common communication channel. Under such scenarios an ON-BOARD-MEMORY would become vestigial. The invention will give the end-user to choose to not include an ON-BOARD-MEMORY on the said device to save the cost incurred. This change can be achieved with minimal effort and no new cost incurred in the form of engineering design modification.

b. To have only storage on-board for the device. It may be required in a special case where in it is only required to enhance the performance and/or functional features of a utility meter but not any communication capability. The invention allows the said device to be able to work even in the absence of the communication modules and this can be achieved by no new modification.

c. To have either of the features as in ‘a’ or ‘b’; or both the features as in ‘a’ and ‘b’ based on the need. The practical scenarios are explained as follows.
The invention is capable of handling the situations of failure of communication failure between the said device and the respective network gateway by storing the transactions with meter inside the on-board-memory available on the said device.
In certain terrains, it may not be possible to have a continuous communication link with the said devices as the terrain may not support the desired minimal operating conditions for continuous network formation. In such cases, the utility may opt to choose to limit the data collection cycle to a very minimum numbers. So, said device then stores all the meter transactions into the on-board-memory on the said device until an explicit data request is received over the secure communication channel.

The said device can be then becomes an economic option for the utilities as no addition NRE costs are involved to change the functionality at the coupler device.

### Feature8:

The said device is programmed to schedule for events such as including but not limited to communication activities, utility meter interaction, and respective device health check-up.

To make the behavior of the said device the more predictable events can be scheduled to run a proper check-up of all the vital system performance parameters, which include but not limited to system voltage, peripheral controls, data ports can occur at planned-intervals.

To reduce the power consumption, the data transactions can be limited to only transmission by enabling the feature. The provision for enabling this feature can be provided as a default event or as a command to the said device, which can be issued by the user via network gateway over a secure communication channel.

To increase the longevity of battery life, when using a battery power to supply for the e power needs of the said device we might need to send the device to reduce the duty cycle of the device. The duty cycle can be reducing by putting the said device at dormant state for longer periods and only allowing priority events. Limiting the utility meter transactions and making them purely request based can achieve this.

### Feature9:

This particular feature relates to ‘electricity consumption measuring meters’. Hence, any references to ‘Utility Meter’ in this subsection of description will represent an ‘Electricity Consumption Meter’

In the event of a Power Outage the said device shifts from PRIMARY_POWER_PORT 120 to AUXILIARY_POWER_SUPPLY 110 to draw the power required for its activities from auxiliary power source. The invention shall enable the said device to shift between mains supply (primary), i.e. SUPPLY_FROM_UTILITY_METER 104 and secondary, i.e. AUXILIARY_POWER_SUPPLY 110 seamlessly and without a delay to increase the availability of the device even in the event of power failure at the mains (primary) power supply. The invention will further generate a POWER_FAILURE message and push it to its NETWORK_GATEWAY through communication channel available.

### Feature10:

It is required to have a control/monitoring mechanism for any network to be maintained and to run data transactions into and out-of the network. In general, it requires a pre-configured device to act as the gateway to network for the external world to interact with the plurality of said devices.

The invention has further advanced the capabilities of the said device so as to enable the said device to be configurable as the gateway for the plurality of utility meters coupled to the said devices. Such an arrangement would reduce the cost to the manufacturer and to the end-user as the two desired activities are able to be carried out through single engineering design.

### Feature11:

The said deices by default come with the information related to their respective ‘Network Gateway’ devices so as to be able to look-up and associate with the respective ‘Network Gateway’. This gives the said devices the ability to respond to their respective network gateway, which can receive and/or transmit data-embedded communication signals over secure communication channels in which the said devices are operating.

### Feature12:

The said devices can also be reconfigured to change their association with one network gateway to another network gateway while not disturbing the regular intended activities of the said devices. In the event of a network gateway requiring maintenance to be performed over it, it is required to move the particular device out of network for a certain time. However, these bring the entire data transactions with the ‘network of utility meters’ to the end-user.

The invention takes care of any such events by passing the information of the new network gateway, which will be replacing the existing network gateway. This information is shared through the network gateway to plurality of said devices over common secure communication channels.

### Case-1:

If the event is due to a SCHEDULED_EVENT the device processes the data as per the EVENT_TYPE for sending it to the respective NETWORK_GATEWAY through the communication channel available at the said device represented as COMM_CHANNEL as represented at 410. The said device then checks for the availability of the communication channel represented as COMM_CHANNEL at the decision point 411. If the communication channel represented as COMM_CHANNEL is available the said device then sends data represented as DATA_TO_GATEWAY, intended for the network gateway through the communication channel available at the said device represented as COMM_CHANNEL as represented at 413. If the communication channel represented as COMM_CHANNEL is not available the said device then stores the data represented as DATA_TO_GATEWAY, intended for the network gateway into the ON_BOARD_MEMORY as represented at 412.

### Case-2:

If the event is due to an ON_DEMAND_EVENT the device processes the data as per the EVENT TYPE for sending it to the respective NETWORK_GATEWAY through the communication channel available at the said device represented as COMM_CHANNEL as depicted at 407. The said device then checks for the availability of the communication channel represented as COMM_CHANNEL at the decision point 408. If the communication channel represented as COMM_CHANNEL is available the said device then sends data, represented as DATA_{—} TO_GATEWAY, intended for the network gateway through the communication channel available at the said device represented as COMM_CHANNEL as represented at 413. If the communication channel represented as COMM_CHANNEL is not available the said. device then discards the message as depicted at 409.

In the event of both CASE-1 & CASE-2 the said device shifts to state represented at 422 and wait for any event to occur. Here the state 422 will lead to the state 307 of FIG. 3, as both are same.

### COMM_EVENT_HANDLER:

COMM_EVENT_HANDLER is a sub-task of the said device, which constitutes the said device's response if COMM_EVENT occurs. A COMM_EVENT will be a data transaction from the respective NETWORK_GATEWAY, where the respective NETWORK_GATEWAY sends a certain amount of data represented as RECEIVED_DATA through the communication channel available at the said device represented as COMM_CHANNEL existing between the said device and the respective NETWORK_GATEWAY. The said device receives the data sent by the respective NETWORK_GATEWAY through the communication channel available at the said device represented as COMM_CHANNEL existing between the said device and the respective NETWORK_GATEWAY and buffers it as depicted at 415. The said device then applies predefined process on the RECEIVED_DATA as depicted at 416. The control then moves to decision point 417.

If DATA_VALID flag is false, said device discards the RECEIVED_DATA.

If DATA_VALID flag is true, said device then moves the control to decision point 419 where the said device further processes the validated RECEIVED_DATA. The device then sends the processed data to the UTILITY_METER through the dedicated data line running between the said device and the respective utility meter. Then said device enables the delay counter represented as DELAY_ENABLE so that the device generates a RESPONSE_FAILURE message if the meter fails to respond in the defined delay time represented as DELAY_OVER, depicted as 311 & 312 in FIG. 3.

Numerous modifications may be made to the present invention, which still fall within the intended scope hereof. Thus, it should be apparent that there has been provided in accordance with the present invention a method and apparatus for welding with a robotic system that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An intelligent coupler device for utility meters comprising:
a communication module to maintain a two-way communication with a network gateway and other neighboring devices through respective communication channels;
a control unit configured for processing and flow control of any communication events;
an oscillator in connection with the control unit via an interface to maintain an instruction clock;
a memory unit for storing and processing incoming and outgoing data;
a real time clock in connection with the control unit to fetch and/or set current date, time and calendar information; and
a primary power port configured for supplying power to all components of the intelligent coupler device requiring power.

2. The intelligent coupler device for the utility meters as claimed in claim 1, wherein the control unit is a microcontroller.

3. The intelligent coupler device for the utility meters as claimed in claim 1, wherein the communication module is configured for an omnipotent communication network which is wired or wireless.

4. The intelligent coupler device for the utility meters as claimed in claim 1, further comprises auxiliary (secondary) power supplies to increase availability of the device even in an event of power failure at a mains (primary) power supply.

5. The intelligent coupler device for the utility meters as claimed in claim 1, further comprises of a plurality of various data ports configured for data acquisition and transfers compatible with data ports available at the utility meter and the communication module.

6. The intelligent coupler device for the utility meters as claimed in claim 1, wherein the control unit converts obtained data from the utility meter to a common standard data format or a custom protocol per an end-user for further processing after retrieval.

7. The intelligent coupler device for the utility meters as claimed in claim 1, wherein the communication module is configured to integrate with a variety of communication modules of different modes of communication communicating on low power ISM band frequencies.

8. The intelligent coupler device for the utility meters as claimed in claim 1, wherein the memory unit is configured for limiting a data collection cycle to a very minimum numbers by storing all meter transactions into the memory unit and transmitting the meter transactions if an explicit data request is received over the communication channel.

9. The intelligent coupler device for the utility meters as claimed in claim 1, wherein the control unit is programmed to schedule for events including communication activities, utility meter interaction, and device health check-up, the check-up including vital system performance parameters which include system voltage, peripheral controls, and data ports at planned-intervals.

10. The intelligent coupler device for the utility meters as claimed in claim 1, wherein a duty cycle can be reduced by putting the device at dormant state for longer periods and only allowing priority events by limiting utility meter transactions and making the transactions purely request based for reducing power consumption.

11. A method for operating a coupler device comprising the steps of:
energizing through main power supply upon availability of power;
checking for performance by reading device performance parameters into ON_BOARD_VITAL_PARAMETERS;
fetching the data related to ON_BOARD_VITAL_PARAMETERS and validating the received values and raising a flag for SYSTEM_READY; and
deciding a process path based on a status of the SYSTEM_READY flag.

12. The method for operating a coupler device as claimed in claim 11, wherein in an event of the device being not ready, further comprising the steps of:
generating a DEVICE_DIAGNOSIS message;
storing the message into an ON_BOARD_MEMORY; and
sending the device into a SLEEP_MODE.

13. The method for operating a coupler device as claimed in claim 11, wherein in an event of the device being ready, further comprising the steps of:
entering into a state of IDLE awaiting event occurrence wherein
under condition of any occurrence off an event, initiating a TRIGGER_PROCESS;
maintaining a dual path for DELAY_PROCESS and other events for identifying a type of event that occurred on the device.

14. The method for operating a coupler device as claimed in claim 12, wherein in the events are classified based on their priority as POWER FAILURE, UTILITY_METER_EVENT, and COMM_EVENT respectively.

15. The method for operating a coupler device as claimed in claim 13, wherein in the events are classified based on their priority as POWER FAILURE, UTILITY_METER_EVENT, and COMM_EVENT respectively.
